(19) United States
(12) Patent Application Publication
(10) Pub. No.: US 2010/0063814 A1
(43) Pub. Date: Mar. 11, 2010

(54) APPARATUS, METHOD AND COMPUTER PROGRAM PRODUCT FOR RECOGNIZING SPEECH

(75) Inventor: Tatsuya Izuha, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/437,593

(22) Filed: May 8, 2009

(30) Foreign Application Priority Data
Sep. 9, 2008 (JP) 2008-230743

(51) Int. Cl. G10L 15/00

(52) U.S. Cl. 704/235; 704/E15.043

(57) ABSTRACT

A speech recognition apparatus includes a document input unit configured to input a document including a reference term which a user refers to; a vocabulary storage unit configured to store a vocabulary list including a group of notation information, reading information and part of speech; a hypernym hyponym relation storage unit configured to store a hypernym hyponym relation tree on a concept between terms; a hypernym acquisition unit configured to search a hypernym of the reference term from the hypernym hyponym relation tree and to acquire the notation information and the part of speech of the hypernym from the vocabulary list; a correspondence storage unit configured to store a correspondence list showing correspondence between the hypernym and the reference term; a display unit configured to display the hypernym; a speech input unit configured to input speech, including the hypernym of the reference term, which the user speaks from the display unit; a speech recognition unit configured to convert the speech into text information by using the vocabulary list; a replacing unit configured to replace the hypernym, which is included in the text information, with the reference term; and an output unit configured to output the text information replaced by the replacing unit.

### CROSS REFERENCE TO RELATED APPLICATIONS

This application is based upon and claims the benefit of priority from the prior Japanese Patent Application No. 2008-230743 filed on Sep. 9, 2008; the entire contents of which are incorporated herein by reference.

### TECHNICAL FIELD

The present invention relates to an apparatus, a method and a computer program product for recognizing speech by converting speech signals into character strings.

### DESCRIPTION OF THE BACKGROUND

In recent years, speech recognition technology, which converts speech information into text information, has progressed and is now able to process a large vocabulary and a highly precise speech input.

However, the extent of the vocabulary of conventional speech recognition systems, which puts the real-time operation in practical use, is approximately tens of thousands of words. If the number of words in the vocabulary increases to more than approximately tens of thousands of words, then speech recognition candidates will correspondingly increase in number, resulting in an undesirable increase in the number of errors during speech recognition processing. This in turn leads to a decrease in the performance of the speech recognition process. Therefore, due to the limited vocabulary, many technical terms and proper nouns are not fully covered.

To solve the problem, JP-A 2003-99089 (KOKAI) discloses that the conventional speech recognition apparatus includes a recognition vocabulary generating unit which generates a speech recognition vocabulary based on an analysis result of a text character sequence.

However, if the number of words, which are generated by the recognition vocabulary generating unit, in the speech recognition vocabulary increases, then performance of speech recognition processing correspondingly decreases as above-mentioned.

### SUMMARY

Accordingly, an advantage of the present invention is to provide a speech recognition apparatus which supports speech inputs, such as technical terms or proper nouns, which are not registered into a speech recognition vocabulary list.

To achieve the above advantage, one aspect of the present invention is to provide a speech recognition apparatus including a document input unit configured to input a document including a reference term which a user refers to; a vocabulary storage unit configured to store a vocabulary list including a group of notation information, reading information and a part of speech; a hypernym hyponym relation storage unit configured to store a hypernym hyponym relation tree on a concept between terms; a hypernym acquisition unit configured to search a hypernym of the reference term from the hypernym hyponym relation tree and to acquire the notation information and the part of speech of the hypernym from the vocabulary list; a correspondence storage unit configured to store a correspondence list showing a correspondence between the hypernym and the reference term; a display unit configured to display the hypernym; speech input unit configured to input speech, including the hypernym of the reference term, which the user speaks from the display unit; a speech recognition unit configured to convert the speech into text information by using the vocabulary list; a replacing unit configured to replace the hypernym, which is included in the text information, with the reference term; and a output unit configured to output the text information replaced by the replacing unit.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following description when considered in conjunction with the drawings.

### BRIEF DESCRIPTION OF THE DRAWINGS

FIG. 1 is a block diagram of an embodiment of a speech recognition apparatus 100 in accordance with an aspect of the invention.

FIG. 2 is an example of the text document inputted into a document input unit 101.

FIG. 3 is the result of the morphological analysis of the text document.

FIG. 4 is the result extracted by a term extraction unit 102.

FIG. 5 is an example of a vocabulary list of a vocabulary storage unit 104.

FIGS. 6A and 6B are examples of a hypernym hyponym relation tree on a concept between terms of a hypernym hyponym relation storage unit 105.

FIG. 7 is the result acquired from all the terms shown in FIG. 4 by a hypernym acquisition unit 103.

FIG. 8 is a list showing corresponding hypernyms and hyponyms stored by a hypernym hyponym correspondence storage unit 108.

FIG. 9 is a drawing that adds the hypernym shown in FIG. 8 to the document shown in FIG. 2.

FIG. 10 is the result of converting the contents, which the user uttered where FIG. 9 is displayed, into text information.

FIG. 11 is the result of the morphological analysis of the text information shown in FIG. 10.

FIG. 12 is the result of detecting the hypernym ID shown in FIG. 8 from the morphological-analysis result shown in FIG. 11.

FIG. 13 is the result of replacing the morphological sequence shown in FIG. 11 based on the detection result of FIG. 12 and the list shown in FIG. 8.

FIG. 14 is the result of outputting the replaced morphological sequence shown in FIG. 13 as text information.

### DETAILED DESCRIPTION

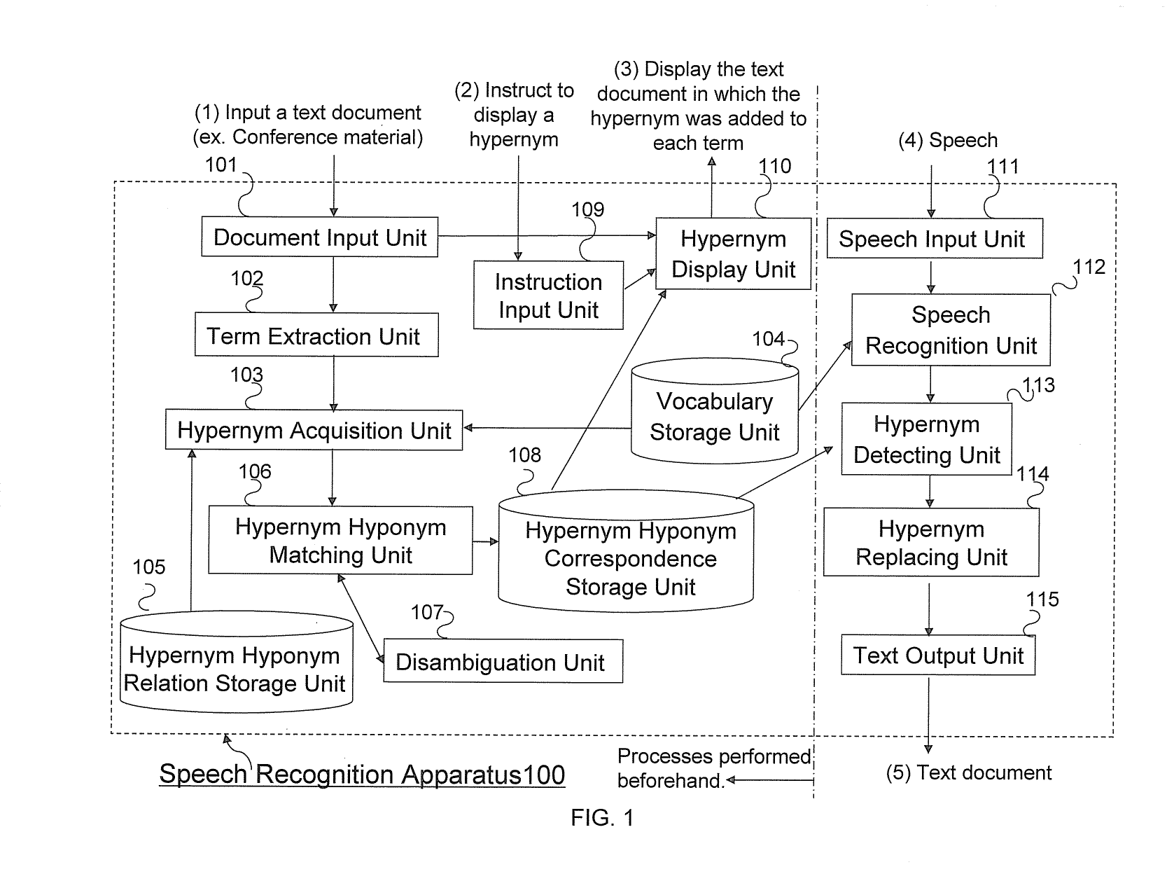

An embodiment in accordance with the invention will be explained with reference to FIGS. 1 to 14. FIG. 1 is a block diagram of an embodiment of a speech recognition apparatus 100. The portion surrounded by the dotted line is the speech recognition apparatus 100, and is included in a personal computer, hand-held electronic device, etc.

(The hypernym is acquired when a term which does not exist in a speech recognition vocabulary list is in a document)

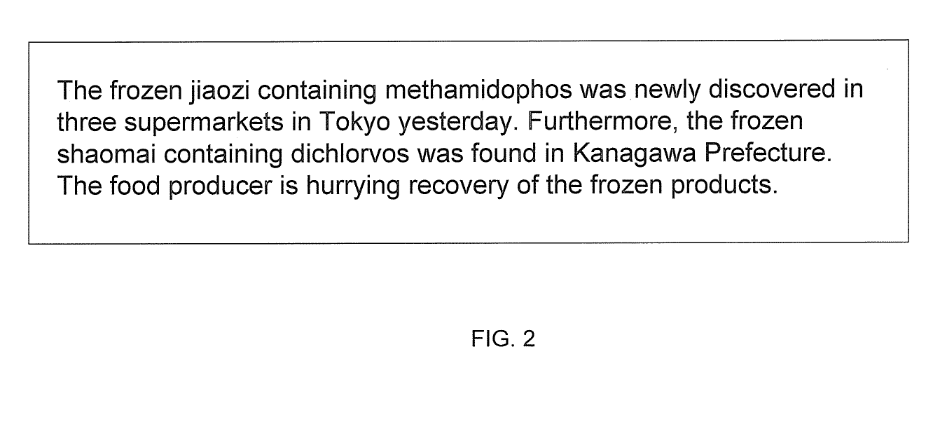

First, a user inputs, into a document input unit 101, a document distributed at a meeting etc. FIG. 2 is an example of the text document inputted into document input unit 101. When a technical term or a proper noun is written in the document, the user who is attending the meeting speaks with reference to the document. When carrying out machine translation of the user's utterance, or when inputting this utterance into reports automatically, speech recognition apparatus 100 is used. In many cases, when speaking with reference to the document distributed at the meeting, a reference term (for example, a technical term or a proper noun) which is written in the document is not stored by vocabulary storage unit 104 for speech recognition processing. Next, speech recognition apparatus 100 performs the following processes.

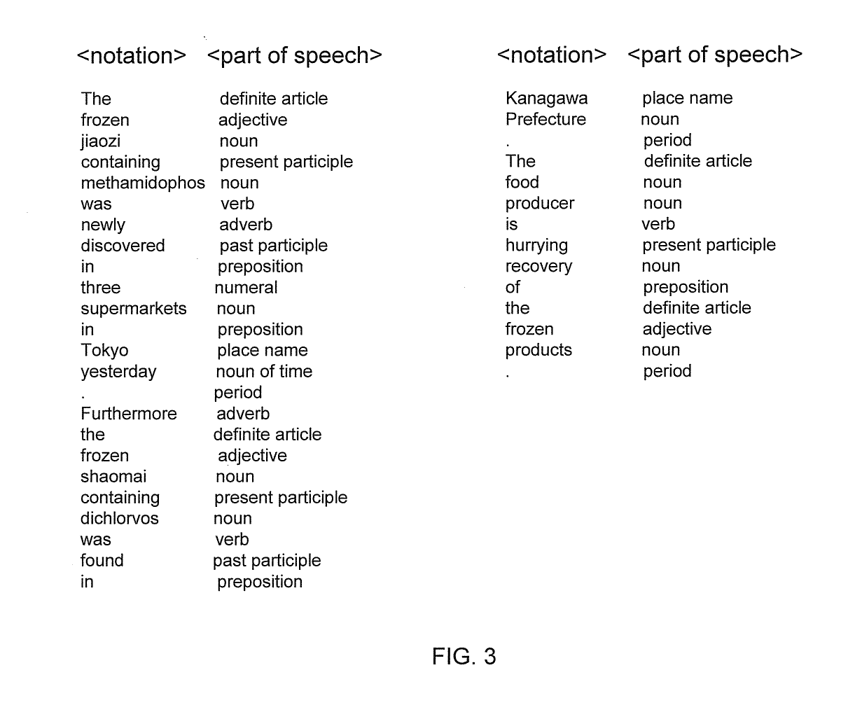

A term extraction unit 102 extracts a term from the text document inputted into document input unit 101. First, term extraction unit 102 performs morphological analysis on the text document. That is to say, it performs a word split process and a part-of-speech assignment process. There are various kinds of publicly known techniques regarding these processes, and explanations of these techniques are abbreviated herein. FIG. 3 is the result of the morphological analysis of the text document.

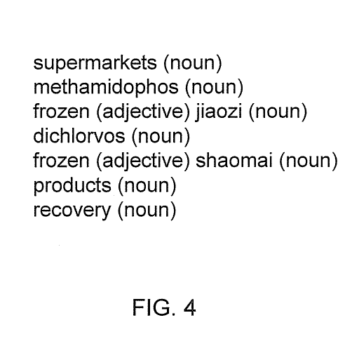

Various techniques are proposed for the technique of extracting a term from the result of the morphological analysis. The simplest technique extracts a noun or an adjective that is independent or continues. FIG. 4 is the result extracted by term extraction unit 102. However, nouns, verbs, adjectives, or adverbs can be extracted.

A hypernym acquisition unit 103 acquires a hypernym corresponding to each extracted term. A hypernym is a generic concept of the extracted term, and is comprised only in a vocabulary stored by a vocabulary storage unit 104.

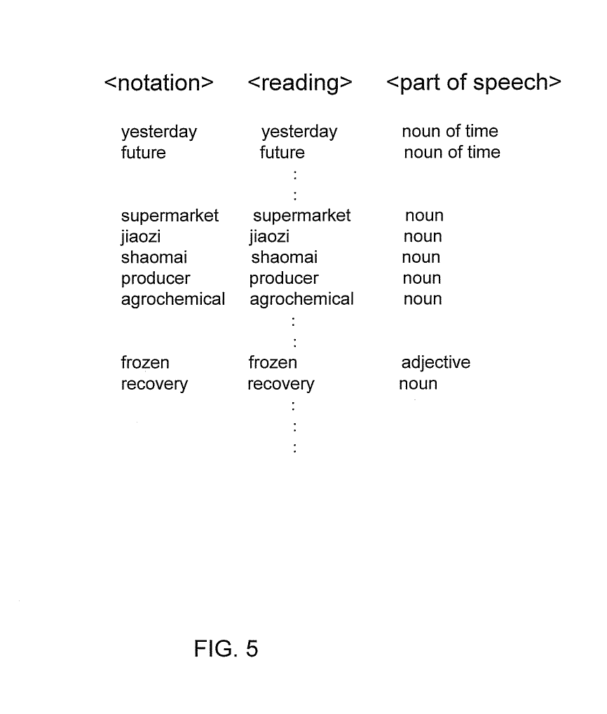

Vocabulary storage unit 104 stores a vocabulary list which can be recognized by a speech recognition unit 112. FIG. 5 is an example of a vocabulary list stored in vocabulary storage unit 104. The vocabulary list comprises a group of “notation”, “reading”, and “part of speech”. Since “reading” of the technical term or the proper noun is not stored in the vocabulary list, speech recognition unit 112 cannot perform speech recognition on the technical term and the proper noun.

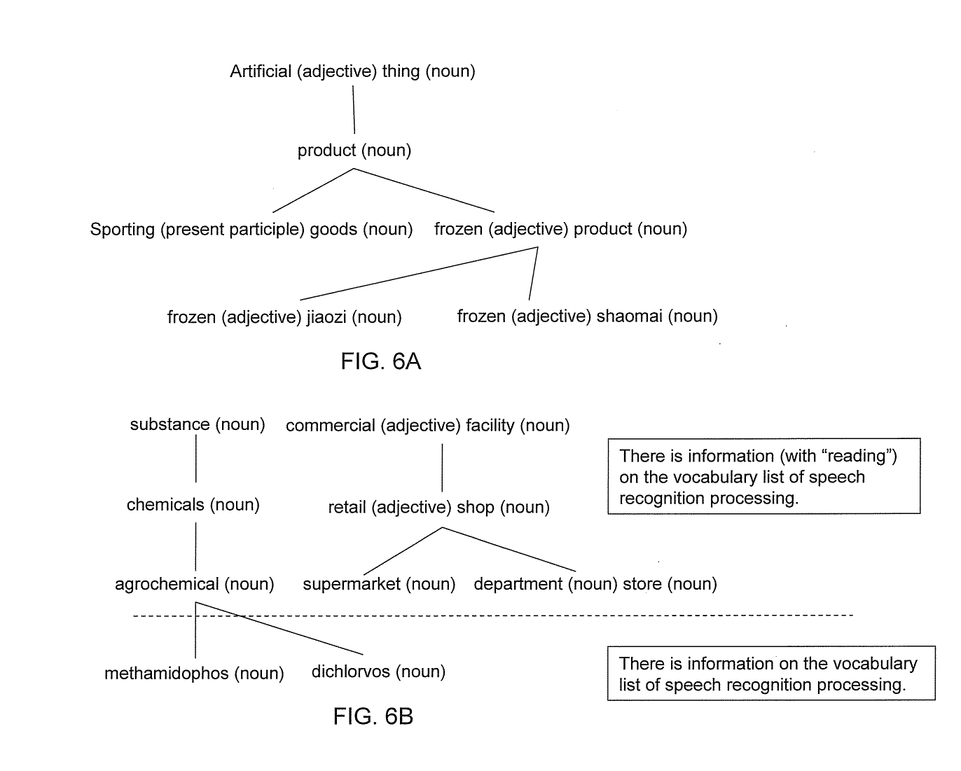

Hypernym acquisition unit 103 refers to a hypernym hyponym relation storage unit 105 to acquire a hypernym of a technical term or a proper noun. Hypernym hyponym relation storage unit 105 stores a hypernym hyponym relation tree on a concept between terms. FIGS. 6A and 6B are examples of the hypernym hyponym relation tree on the concept between terms of hypernym hyponym relation storage unit 105. Hypernym hyponym relation storage unit 105 stores “notation” components and “part of speech” components but does not store “reading” components.

The terms “super” and “methamidophos” shown in FIG. 4 are taken as an example, and this example explains the processing performed by hypernym acquisition unit 103. Hypernym acquisition unit 103 confirms whether each word which constitutes a term “super” is registered into vocabulary storage unit 104.

1) Term “super”

A term “super” comprises one word “super.”, so it is necessary to check only on one word “super”. Hypernym acquisition unit 103 searches whether a noun “super” is registered in the vocabulary list shown in FIG. 5. If the noun “super” is registered in the vocabulary list, then acquisition of a hypernym of the noun “super” is not performed.

2) Term “methamidophos”

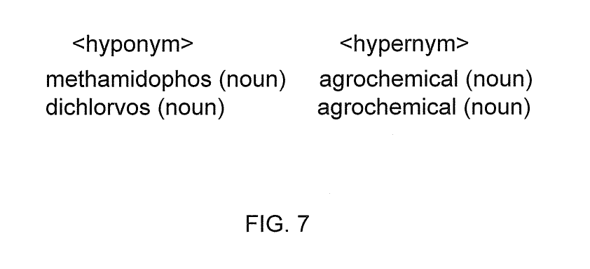

The term “methamidophos” comprises one word. However, it is not registered even if the vocabulary list shown in FIG. 5 is checked for the word “methamidophos”. Instead, a hypernym of “methamidophos” is searched with reference to the hypernym hyponym relation tree shown in FIG. 6. And “agricultural chemicals” is then extracted as the hypernym of “methamidophos”. Since “agricultural chemicals” is registered into the vocabulary list shown in FIG. 5, a “notation” and a “part of speech” of “agricultural chemicals” are extracted from the vocabulary list shown in FIG. 5. FIG. 7 is the result acquired by hypernym acquisition unit 103 from all the terms shown in FIG. 4.

A hypernym hyponym matching unit 106 extracts a corresponding hyponym from a processing result of hypernym acquisition part 103 by using a hypernym as a key. Alternatively, hypernym hyponym matching unit 106 extracts a corresponding hypernym from a processing result of hypernym acquisition part 103 by using a hyponym as a key. In the case when two or more hyponyms are matched to one hypernym, a numeral is added to an end of a hypernym as an identifier by a disambiguation unit 107.

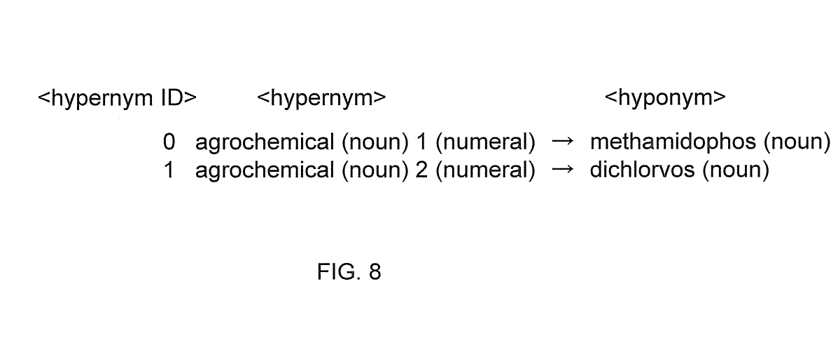

FIG. 8 shows a result of the processing hypernym hyponym matching unit 106 and disambiguation unit 107 processes the data shown in FIG. 7. A hypernym hyponym correspondence storage unit 108 stores a list showing corresponding hypernyms and hyponyms shown in FIG. 8.

(A Hypernym is Displayed on a User)

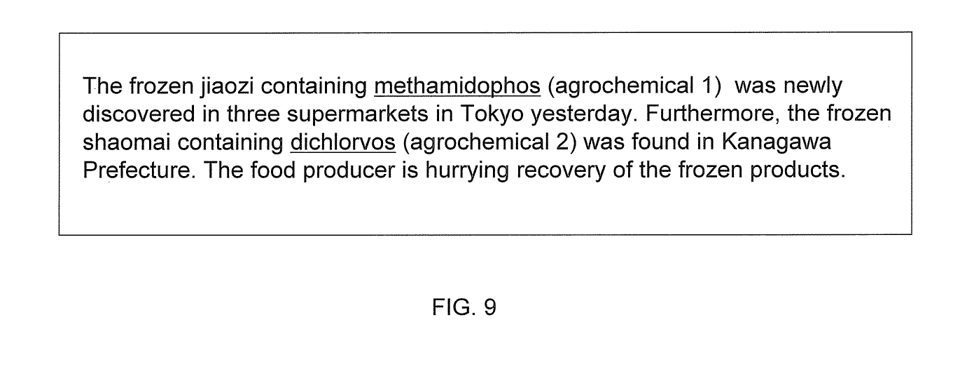

An instruction input unit 109 inputs an instruction from the user which display a hypernym. A hypernym display unit 110 adds a hypernym stored by hypernym hyponym correspondence storage unit 108 to the text document inputted into document input unit 101, and displays the added text document. FIG. 9 is a drawing that adds the hypernym shown in FIG. 8 to the text document shown in FIG. 2.

(A User's Utterance is Recognized)

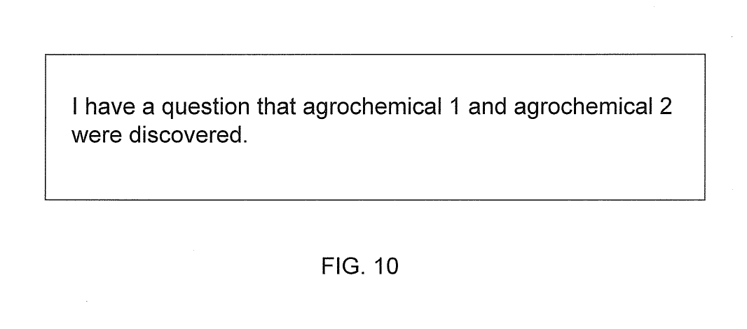

Hypernym display unit 110 displays a hypernym as shown in FIG. 9. And if a user says something containing this hypernym, a speech input unit 111 inputs the utterance. Speech recognition unit 112 converts the inputted utterance into text information by using vocabulary storage unit 104. FIG. 10 shows the converted text information.

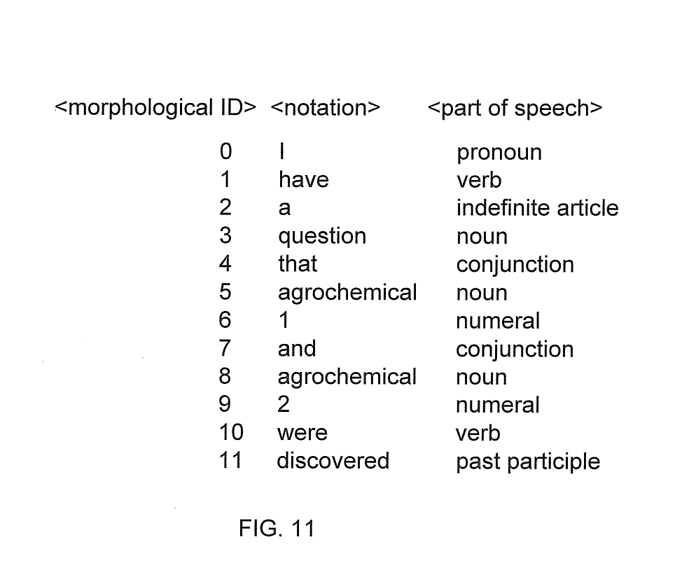

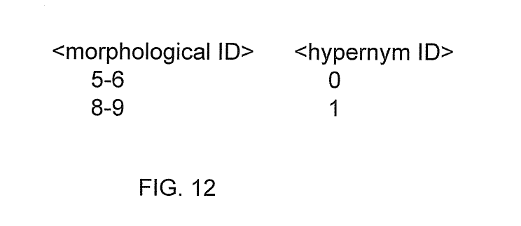

A hypernym detecting unit 113 detects a hypernym stored by hypernym hyponym correspondence storage unit 108 from the text information shown in FIG. 10. Hypernym detecting unit 13 first performs morphological analysis on the text information shown in FIG. 10. FIG. 11 shows the result of the morphological analysis. Next, it detects a morphological ID shown in FIG. 11 corresponding to a hypernym ID shown in FIG. 8. FIG. 12 shows the result of the detection. The hypernym of hypernym ID=0 is detected in the section of morphological ID=5-6. The hypernym of hypernym ID=1 is detected in the section of morphological ID=8-9.

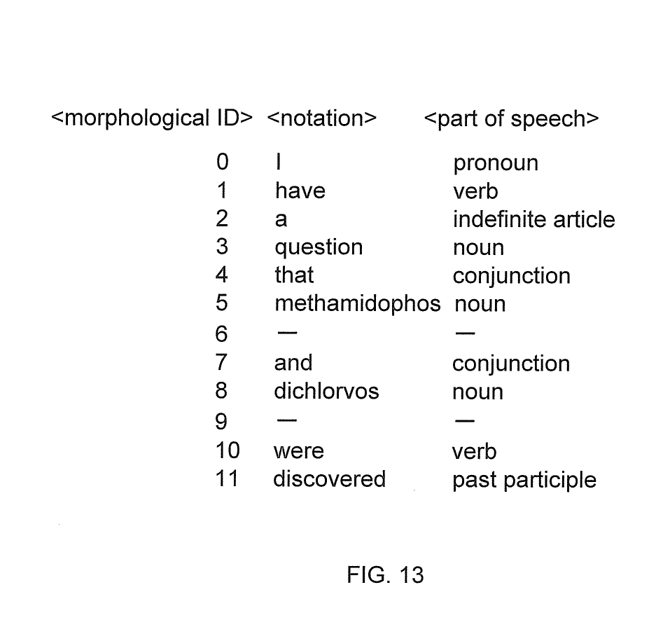

The hypernym replacing unit 114 replaces the hypernym detected by hypernym detecting unit 113 with the hyponym shown in FIG. 8. FIG. 13 shows the result of replacing a morphological sequence shown in FIG. 11 based on the detection result shown in FIG. 12 and the list shown in FIG. 8. By carrying out the replacement, the values of morphological ID=6 and morphological ID=9 are deleted.

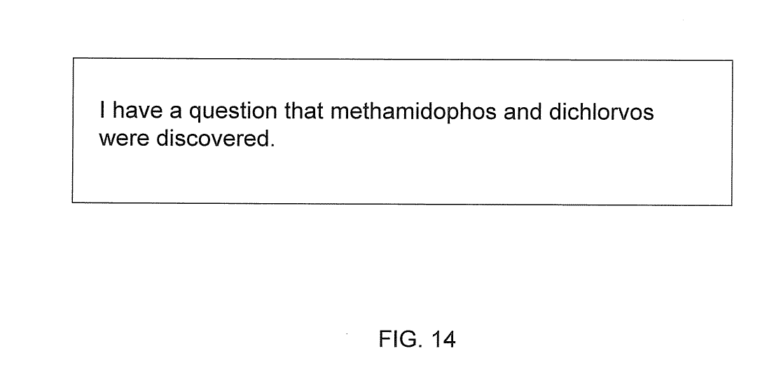

A text output unit 115 outputs the result shown in FIG. 13 as text information. FIG. 14 shows the text information. Since morphological ID=6 and morphological ID=9 have had their values deleted as mentioned above, the text information is outputted in a form where these values have been deleted.

When a vocabulary list of speech recognition processing does not contain a term included in a document (for example, conference material) which a user refers to, a hypernym of the term which is included in the vocabulary list is displayed to the user. Next, the hypernym included in a speech recognition result of a user utterance is replaced by the original term. This embodiment supports speech inputs (for example, such as a technical terms not registered in the vocabulary list) and makes speech recognition processing easier. Using the speech recognition processing and apparatus described herein, it is not necessary to increase the size of a speech recognition vocabulary list or vocabulary storage unit in order to process additional speech.

The results of this speech recognition processing can be used as an input to an application software, for example, machine translation and automatic conference note creation.

Although the above embodiments show the processing as being carried out in a PC, it is also possible to have a server or web based processing apparatus as the speech recognition apparatus. The speech recognition apparatus can also be a normal computer with components like a control device such as CPUs, memory devices such as ROMs and RAMs, external storage devices such as HDDs, display devices and input devices such as keyboards and mice.

It is also possible to realise the above invention using the standard hardware found in computers on the mass market today. The execution of the programs is carried out by the modules possessing the above listed capabilities. The program can either be in the form of installable files or executable files stored on computer-readable media like CD-ROMs, floppy disks, CD-Rs, DVDs, etc. It can also be preinstalled on memory modules like ROMs. As used in this application, the terms “component”, “unit” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems or units (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art recognize many modifications may be made to this configuration without departing from the scope or spirit of the claimed subject matter.

While the subject matter is described above in the general context of computer-executable instructions of a computer program that runs on a computer and/or computers, those skilled in the art recognize that the innovation also may be implemented in combination with other program modules. Generally, program modules include routines, programs, components, data structures, and the like, which perform particular tasks and/or implement particular abstract data types. Moreover, those skilled in the art appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

Numerous modifications and variations of the present invention are possible in light of the above teachings. It is therefore to be understood that, within the scope of the appended claims, the present invention can be practiced in a manner other than as specifically described herein.

What is claimed is:

1. A speech recognition apparatus, comprising:
a document input unit configured to input a document comprising a reference term which a user refers to;
a vocabulary storage unit configured to store a vocabulary list comprising a group of notation information, reading information, and a part of speech;
a hypernym hyponym relation storage unit configured to store a hypernym hyponym relation tree on a concept between terms;
a hypernym acquisition unit configured to search a hypernym of the reference term from the hypernym hyponym relation tree and to acquire the notation information and the part of speech of the hypernym from the vocabulary list;
a correspondence storage unit configured to store a correspondence list showing correspondence between the hypernym and the reference term;
a display unit configured to display the hypernym;
speech input unit configured to input speech, including the hypernym of the reference term, which the user speaks from the display unit;
a speech recognition unit configured to convert the speech into text information by using the vocabulary list;
a replacing unit configured to replace the hypernym, which is included in the text information, with the reference term; and
an output unit configured to output the text information replaced by the replacing unit.

2. The apparatus according to claim 1, wherein parts of speech of the terms stored by the hypernym hyponym relation tree are nouns.

3. The apparatus according to claim 1, wherein the display unit displays the hypernym which is added to the document.

4. The apparatus according to claim 1, wherein the correspondence storage unit stores identifiers of the hypernym corresponding to each of the reference terms.

5. The apparatus according to claim 4, wherein the display unit displays the hypernym and the identifier.

6. The apparatus according to claim 5, further comprising a detecting unit,
wherein the speech input unit inputs the speech comprising the hypernym and the identifier,
the speech recognition unit converts the speech into the text information,
the detecting unit performs a morphological analysis on the text information and detects the hypernym and the identifier.

7. The apparatus according to claim 6, wherein the replacing unit replaces the hypernym and the identifier with the reference term stored by the correspondence list.

8. The apparatus according to claim 7, wherein the output unit outputs the text information, replaced by the replacing unit, with the identifier being deleted.

9. A speech recognition method, comprising:
inputting a document including a reference term which a user refers to;
storing a vocabulary list comprising a group of notation information, reading information, and a part of speech;
storing a hypernym hyponym relation tree on a concept between terms;
searching a hypernym of the reference term from the hypernym hyponym relation tree;
acquiring the notation information and the part of speech of the hypernym from the vocabulary list;
storing a correspondence list showing correspondence between the hypernym and the reference term;
displaying the hypernym;
inputting speech, comprising the hypernym of the reference term, which the user speaks;
converting the speech into text information by using the vocabulary list;
replacing the hypernym, which is comprised in the text information, with the reference term; and
outputting replaced text information.

10. The method according to claim 9, wherein the reference term is a noun.

11. The method according to claim 9, wherein the reference term is a technical term.

12. The method according to claim 9, wherein correspondence between the hypernym and the reference term comprises identifiers of the hypernym.

13. A computer program product having a computer readable medium comprising programmed instructions for processing text information, wherein the instructions, when executed by a computer, cause the computer to perform:
inputting a document comprising a reference term which a user refers to;
storing a vocabulary list including a group of notation information, reading information, and a part of speech in a vocabulary storage unit;
storing a hypernym hyponym relation tree on a concept between terms in a hypernym hyponym relation storage unit;
searching a hypernym of the reference term from the hypernym hyponym relation tree;
acquiring the notation information and the part of speech of the hypernym from the vocabulary list;
storing a correspondence list showing correspondence between the hypernym and the reference term in a correspondence storage unit;
displaying the hypernym on a display unit;
inputting speech, comprising the hypernym of the reference term, which the user speaks from the display unit;
converting the speech into text information by using the vocabulary list;
replacing the hypernym, which is included in the text information, with the reference term; and
outputting replaced text information.

14. The method according to claim 13, wherein the reference term is a noun.

15. The method according to claim 13, wherein the reference term is a technical term.

16. The method according to claim 13, wherein correspondence between the hypernym and the reference term comprises identifiers of the hypernym.
